(19) United States
(12) Patent Application Publication
(10) Pub. No.: US 2023/0011123 A1
(43) Pub. Date: Jan. 12, 2023

(54) FILL-LEVEL MEASURING DEVICE

(71) Applicant: Endress+Hauser SE+Co. KG, Maulburg (DE)

(72) Inventors: Winfried Mayer, Buch (DE); Harald Faber, Lörrach (DE)

(21) Appl. No.: 17/756,816

(22) PCT Filed: Nov. 20, 2020
(86) PCT No.: PCT/EP2020/082849

§ 371 Date: Jun. 2, 2022

(30) Foreign Application Priority Data
Dec. 5, 2019 (DE) 10 2019 133 245.1

(51) Int. Cl. G01F 23/284; G01S 7/40; G01S 13/88

(52) U.S. Cl. CPC G01F 23/284; G01S 7/4056; G01S 13/88

(57) ABSTRACT

A radar-based fill-level measuring device that operates, for example, according to the FMCW principle or the pulse time-of-flight principle comprises a temperature sensor. Thus, the measurement rate at which the fill level is determined can be controlled according to the measured temperature in such a way that, at least above a defined limit temperature, the measurement rate is reduced as the temperature increases further. Furthermore, the measurement can be completely stopped if the measured temperature exceeds a predefined maximum temperature, in particular 150° C. The development of heat in the fill-level measuring device is counteracted by the reduction of the measurement rate. The measurement rate is thereby adaptively adjusted with respect to the ambient temperature such that, even at elevated ambient temperatures, which can occur in the case of cleaning processes, the fill-level measuring device remains at least conditionally fit for use.

The invention relates to a fill-level measuring device suitable for high-temperature applications.

In automation technology, especially for process automation, field devices are often used, which serve to detect various measured variables. The measured variable to be determined may, for example, be a fill level, a flow, a pressure, the temperature, the pH value, the redox potential, a conductivity, or the dielectric value of a medium in a process plant. In order to detect the corresponding measured values, the field devices each comprise suitable sensors or are based on suitable measuring principles. A variety of such types of field devices is produced and marketed by the Endress+Hauser group of companies.

For measuring the fill level of filling materials in containers, radar-based measuring methods have become established since they are robust and require minimum maintenance. Within the scope of the invention, the term “container” is also understood to mean containers that are not closed, such as basins, lakes, or flowing bodies of water. A key advantage of radar-based measuring methods lies in the ability to measure the fill level quasi-continuously. In the context of this patent application, the term “radar” refers to radar signals having frequencies between 0.03 GHz and 300 GHz. Typical frequency bands at which fill-level measurement or distance measurement is generally performed are 2 GHz, 26 GHz, 79 GHz, or 120 GHz. The two common measuring principles here are the pulse time-of-flight principle (also known under the term “pulse radar”) and the FMCW principle (“frequency-modulated continuous wave”). A fill-level measuring device which operates according to the pulse time-of-flight method is described, for example, in published patent application DE 10 2012 104 858 A1. For a typical construction of FMCW-based fill-level measuring devices, reference is made by way of example to published patent application DE 10 2013 108 490 A1.

In the case of both measuring principles, the fill level or the distance to the filling material is measured cyclically at a defined measurement rate. The measuring principles of FMCW and pulse radar are described in greater detail in “Radar Level Detection, Peter Devine, 2000,” for example.

Fill-level measuring devices are generally used in process environments in which the outside temperature or room temperature prevails. Specifically in the case of hygienically sensitive process plants, such as in the food industry, temporary cleaning cycles are, however, often performed in corresponding process containers at temperatures of more than 130° C., which is close to the junction temperature of semiconductor-based circuits of about 150° C. For this reason, the corresponding semiconductor circuit and thus the fill-level measuring device do not work properly above this temperature. Due to the resulting low temperature reserve, the fill-level measuring device can therefore not be used at least during and after the cleaning cycles.

The invention is therefore based on the object of providing a fill-level measuring device that can also be used at an increased ambient temperature.

The invention achieves this object by means of a radar-based fill-level measuring device for measuring a fill level of a filling material located in a container. For this purpose, the fill-level measuring device comprises at least:
a signal-generating unit designed to generate a high-frequency electrical signal corresponding to an adjustable measurement rate,
an antenna arrangement, by means of which the high-frequency signal can be emitted as a radar signal in the direction of the filling material and can be received as a corresponding receive signal after reflection on the surface of the filling material,
an evaluation unit designed to redetermine the fill level cyclically at least on the basis of the receive signal at the adjustable measurement rate,
a temperature sensor designed to measure the temperature at the signal-generating unit and/or at the evaluation unit.

According to the invention, the signal-generating unit and the evaluation unit are designed to control the measurement rate as a function of the measured temperature in such a way that the measurement rate is reduced, especially, linearly or stepwise, as the temperature increases, at least above a defined limit temperature of, for example, 100° C. Consequently, in spite of their proximity to cleaning processes, primarily components that heat up significantly in the signal-generating unit and the evaluation unit, such as any amplifiers, only heat up to a limited extent. As a result, the components of the fill-level measuring device reaching the junction temperature can be flexibly prevented. By the control according to the invention, the fill-level measuring device can thus be used at a correspondingly low measurement rate even during any cleaning cycles if appropriate.

With reference to the fill-level measuring device, the term “unit” within the scope of the invention is understood in principle to mean any electronic circuit that is suitably designed for the respective intended purpose. Depending on the requirement, it can therefore be an analog circuit for generating or processing corresponding analog signals. However, it can also be a digital circuit, such as a microcontroller or a storage medium in interaction with a program. In this case, the program is designed to perform the corresponding method steps or to apply the necessary calculation operations of the respective unit. In this context, various electronic units of the fill-level measuring device in the sense of the invention can potentially also access a common physical memory or be operated by means of the same physical digital circuit.

The fill-level measuring device according to the invention can be developed by designing the signal-generating unit and the evaluation unit to completely stop the fill-level measurement if the measured temperature exceeds a predefined maximum value, especially, the junction temperature of 150° C. This is advantageous especially if the signal-generating unit or the evaluation unit is designed as a monolithic component of an ASIC. If the signal-generating unit comprises a transmission amplifier for amplifying the high-frequency signal, it is also possible to arrange the temperature sensor directly on the transmission amplifier since such an amplifier heats up by far the most in practice and thus represents the hottest location, at least in the case of an ASIC-based design. In addition, the transmission amplifier is normally arranged close to the antenna in relation to most of the other components of the fill-level measuring device and thus very close to any cleaning cycles.

Within the scope of the invention, the fill-level measuring device can be designed both according to the pulse time-of-flight method and according to the FMCW method: In the case of the pulse time-of-flight method, the signal-generating unit is to be designed such that the high-frequency electrical signal is generated according to the pulse time-of-flight method. The evaluation unit is correspondingly designed to determine the fill level according to the pulse time-of-flight method on the basis of the sampled receive signal.

When implementing the FMCW method, the signal-generating unit is to be correspondingly designed to generate the high-frequency electrical signal according to the FMCW method, or the evaluation unit is to be designed such that the fill level is determined according to the FMCW method by mixing the high-frequency signal and the receive signal.

In correspondence with the fill-level measuring device according to the invention, the object on which the invention is based is also achieved by a method for operating a measuring device according to one of the previously described embodiment variants. Accordingly, the method comprises at least the following method steps:
Generating a high-frequency electrical signal corresponding to a variable measurement rate,
Emitting the high-frequency signal as a radar signal in the direction of the object,
Receiving the reflected radar signal as an electrical receive signal after reflection on the object,
Cyclically redetermining the distance on the basis of at least the receive signal at the adjustable measurement rate,
Measuring the temperature at the signal-generating unit and/or at the evaluation unit.

In this case, the measurement rate is controlled as a function of the measured temperature in such a way that, at least above a defined limit temperature, the measurement rate is reduced as the temperature increases.

The invention is explained in more detail with reference to the following figures. The following is shown:

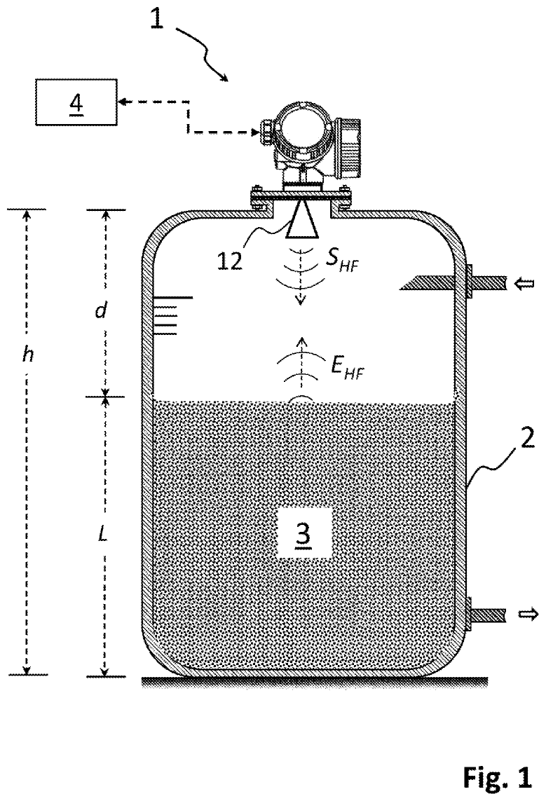

FIG. 1: a typical arrangement of a radar-based fill-level measuring device on a container,

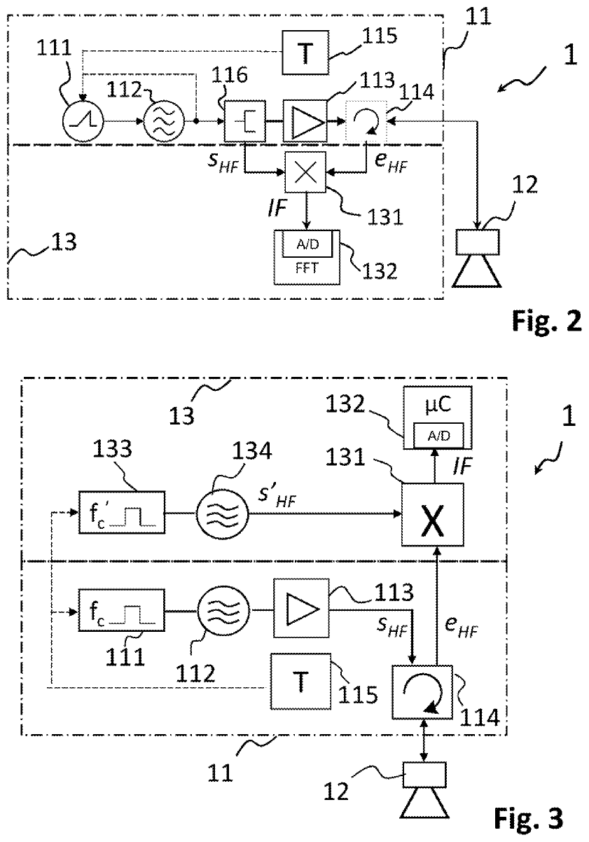

FIG. 2: a circuit diagram of an FMCW radar-based fill-level measuring device,

FIG. 3: a circuit diagram of a fill-level measuring device which operates according to the pulse time-of-flight method, and

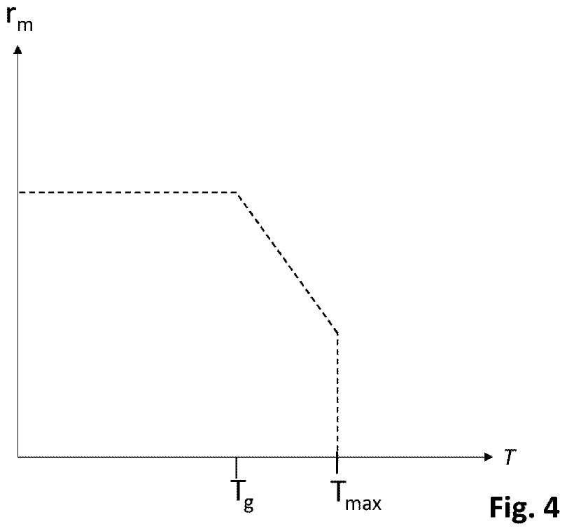

FIG. 4: a control of the measurement rate according to the invention as a function of the temperature in the fill-level measuring device.

For a basic understanding of the distance measurement according to the invention, FIG. 1 shows a typical arrangement of a freely radiating, radar-based fill-level measuring device 1 on a container 3. In the container 3 is a filling material 2, whose fill level L is to be determined by the fill-level measuring device 1. For this purpose, the fill-level measuring device 1 is mounted on the container 3 above the maximum permissible fill level L. Depending on the field of application, the height h of the container 3 can be between only 30 cm up to 125 m.

As a rule, the fill-level measuring device 1 is connected via a bus system, such as “Ethernet,” “PROFIBUS,” “HART,” or “Wireless HART,” to a higher-level unit 4, such as a process control system or a decentralized database. On the one hand, information about the operating status of the fill-level measuring device 1 can thus be communicated. On the other hand, information about the fill level L can also be transmitted via the bus system in order to control any inflows or outflows that may be present at the container 3.

Since the fill-level measuring device 1 shown in FIG. 1 is designed as freely radiating radar measuring device, it comprises a corresponding transmitting/receiving antenna 12. As indicated, the antenna 12 can be designed as a horn antenna, for example. Regardless of the design, the transmitting/receiving antenna 12 is oriented such that a corresponding radar signal S_{HF} is emitted in the direction of the filling material 3 according to the FMCW principle or the pulse time-of-flight principle.

The radar signal S_{HF} is reflected at the surface of the filling material 3 and, after a corresponding signal time-of-flight, is correspondingly received as an electrical receive signal e_{HF} by the transmitting/receiving antenna 12. The signal time-of-flight of the radar signal S_{HF}, E_{HF} depends on the distance d=h−L of the fill-level measuring device 1 from the filling material surface.

In contrast to the embodiment variant shown, it is also possible for two separate antennas to be used for separate transmission and reception of the radar signal S_{HF}, E_{HF}, instead of a single transmitting/receiving antenna 12. Another alternative consists of using an electrically conductive probe, such as a waveguide or a coaxial cable, which extends toward the container bottom. This embodiment variant is known as TDR (“time-domain reflectometry”).

The basic circuit design of a fill-level measuring device 1 operating according to the FMCW method is illustrated in FIG. 2: In order to generate the radar signal S_{HF}, the measuring device 1 comprises a signal-generating unit 11, which generates a corresponding high-frequency electrical signal s_{HF} and supplies it to the antenna 12. The frequency of the high-frequency signal s_{HF} defines the frequency of the radar signal S_{HF} in the microwave range. Therefore, the high-frequency signal-generating unit 11, 12 must be designed to generate the high-frequency electrical signal s_{HF} with the ramp-shaped change of its frequency required in FMCW.

As shown in FIG. 2, for generating the high-frequency signal s_{HF}, the signal-generating unit 11 comprises a high-frequency oscillator 112, which is controlled by means of a ramp-generating unit 111. The control takes place according to a phase control (known as “phase locked loop, PLL”). The frequency of the high-frequency oscillator 112 is thus stabilized on the one hand. On the other hand, the ramp-shaped frequency change of the high-frequency signal s_{HF} is set thereby.

With the ramp-shaped frequency change according to the FMCW principle, the frequency of the high-frequency signal s_{HF} increases in a periodically repeating manner within a predefined frequency band Δf at a constant rate of change. The periodicity of the individual frequency ramps may be within a range of a few 100 ms. The duration of the individual ramp can be within the range between 100 μs and 100 ms. The position of the frequency band Δf is to be set taking into account regulatory requirements, for which reason the frequency bands about frequencies of 6 GHz, 26 GHz, 79 GHz, or 120 GHz are preferably implemented as frequency band Δf. The bandwidth lies especially between 0.5 GHz and 10 GHz, depending on the position of the frequency band Δf.

In practice, the high-frequency signal s_{HF} is not continuously generated in the case of FMCW. Rather, the ramp-shaped change is interrupted for a defined pause time after a defined number of successive frequency ramps. In the case of FMCW, the corresponding measurement rate rₘ at which the FMCW-based fill-level measuring device 1 cyclically redetermines the fill level L results from this number of successive frequency ramps, or from their respective ramp duration, and the subsequent pause time. In practice, the cycle duration in this case is between 0.3 Hz and 30 Hz.

For transmission, the high-frequency electrical signal s_{HF} in the signal-generating unit 11 is supplied to the antenna 12 via a signal divider 116, a transmission amplifier 113, and a transmitting/receiving switch 114. The incoming radar signal E_{HF}, which is reflected by the filling material surface, is converted back into a purely electrical receive signal e_{HF} by the transmitting/receiving antenna 12. Subsequently, after any reception amplification (not shown in FIG. 2), the receive signal e_{HF} is mixed in an evaluation unit 13 by means of a mixer 131 with the high-frequency signal s_{HF} to be transmitted. For this purpose, the high-frequency signal s_{HF} is branched from the signal divider 116 of the signal-generating unit 11. This generates an evaluation signal IF which is typical in the FMCW method and forms the basis for determining the distance d or the fill level L. In this case, the frequency of the evaluation signal IF according to the FMCW principle is proportional to the distance d from the fill level surface.

In order to determine the frequency of the evaluation signal IF, an analog/digital converter of a computing unit 134 digitizes the evaluation signal IF in the evaluation unit 13. The computing unit 134 can thus subject the digitized evaluation signal to a (fast) Fourier transformation, or FFT for short. The frequency of the global maximum of the corresponding FFT spectrum ideally corresponds to the distance d from the filling material surface.

A circuit diagram of a fill-level measuring device 1, which operates according to the pulse time-of-flight method, is shown in FIG. 3: In order to generate the pulse-shaped high-frequency signal SHF, the circuit of the fill-level measuring device 1 shown in FIG. 3 also comprises a signal-generating unit 11. In the case of the pulse time-of-flight method, the signal-generating unit 11 is designed such that it generates high-frequency electrical pulses s_{HF} at a defined clock rate f_{c}. For this purpose, the signal-generating unit 11 in the shown exemplary embodiment comprises a first pulse generator 111 that actuates a first high-frequency oscillator 112.

The frequency of the microwave pulses SHF, EHF is established by the oscillation frequency of the high-frequency oscillator 112. In the simplest case, the high-frequency oscillator 112 can be designed as an oscillating crystal. A VCO (“voltage-controlled oscillator”) can also be used. In this case, the high-frequency oscillator 112 is actuated by the pulse generator 111 by means of a corresponding DC voltage signal. The pulse generator 111 thereby defines the pulse duration of the individual microwave pulses SHF and the clock rate f_{c} at which the microwave pulses SHF are emitted. As standard, a semiconductor-based digital resonant circuit is used as the high-frequency oscillator 112. The clock rate f_{c} at which the individual microwave pulses s_{HF} are excited is between 100 KHz and 1 MHz in practice. The high-frequency pulses s_{HF} thereby generated by the high-frequency oscillator 112 are supplied to the antenna 12 analogously to the FMCW method via a transmission amplifier 113 and a transmitting/receiving switch 114 so that they are correspondingly emitted as microwave pulses SHF.

Since the reflected microwave pulses EHF are also received via the antenna 121, the transmitting/receiving switch 114 supplies the corresponding receive signal EHF to a mixer 131 in the evaluation unit of the fill-level measuring device 1. In contrast to the shown embodiment variant, an electrically conductive probe, such as a waveguide or a coaxial cable, which extends toward the container bottom can also be used instead of the antenna 12. In contrast to the circuit shown in FIG. 2, in the implementation of this embodiment variant known by the term TDR (“time-domain reflectometry”), the high-frequency oscillators 111, 133 are not required.

By means of the mixer 131, the undersampling of the receive signal e_{HF} characteristic of the pulse time-of-flight method is carried out. For this purpose, the receive signal e_{HF} is mixed with electrical sampling pulses s′_{HF} by the mixer 131. In this case, the sampling rate f′_{c} at which the sampling pulses s′_{HF} are generated differs by a defined relative deviation Φ of far less than 0.1 per thousand from the clock rate f_{c} of the generated high-frequency pulses s_{HF}.

The sampling pulses s_{HF} are generated in the evaluation unit 13 analogous to the signal-generating unit 13 by a second pulse generator 133 which actuates a second high-frequency oscillator 134. Thus, correspondingly to the high-frequency pulses s_{HF}, the frequency of the sampling pulses s′_{HF} is defined by the second high-frequency oscillator 134. In this case, the frequency of both high-frequency oscillators 112, 134 is set identically in practice. In this case, the second pulse generator 134 in turn controls the sampling rate f_{c} at which the sampling pulses s′_{HF} are generated.

Mixing the receive signal e_{HF} with the electrical sampling pulses s′_{HF} by means of the mixer 131 generates an evaluation signal IF which is typical for the pulse time-of-flight method and represents the receive signal e_{HF} in a time-expanded manner. The time expansion factor is proportional to the deviation Φ between the clock rate f_{c} and the sampling rate f_{c}. Accordingly, in the case of the pulse time-of-flight method, the measurement rate rₘ is defined as the clock rate f_{c} divided by the deviation Φ according to

$${r}_{m} = \frac{{f}_{c}}{φ}$$

The advantage of the time expansion is that the evaluation signal IF can be evaluated considerably more easily from a technical point of view due to the time expansion in comparison to the pure receive signal e_{HF}: The reason for this is that the receive signal e_{HF} has a correspondingly short time scale tin the nanosecond range due to the high speed of propagation of the microwave pulses S_{HF}, E_{HF} at the speed of light. The time expansion results in the evaluation signal ZF having a time scale in the millisecond range.

By means of the time-expanded evaluation signal IF, the computing unit 132, after corresponding analog/digital conversion, subsequently again determines the fill level L by determining the signal maximum corresponding to the distance d in the evaluation Signal IF.

Both the FMCW-based embodiment variant shown in FIG. 2, and the pulse time-of-flight-based variant of the fill-level measuring device 1 shown in FIG. 3 respectively comprise a transmission amplifier 113 in their signal-generating unit 11. With relation to the further components of the signal-generating unit 11 and of the evaluation unit 13, this component heats up most in practice during measuring mode. In a large number of applications, this is not critical since the fill-level measuring device 1 is often only used at outside temperature or room temperature. As a result, the heat arising in the transmission amplifier 113 can be sufficiently dissipated so that the temperature remains far below the critical junction temperature of 150° C. However, it becomes critical if the fill-level measuring device 1 is used at sites of use at which, at least temporarily, more than 100° C. prevail, such as in cleaning processes during food production.

According to the invention, the two embodiment variants of the fill-level measuring device 1, which are described in FIGS. 2 and 3, therefore comprise a temperature sensor 115 which is mounted on the transmission amplifier 113 in the signal-generating unit 11 so that the temperature there can be measured. This makes it possible to configure the signal-generating unit 11 and the evaluation unit 13 of the fill-level measuring device 1 in such a way that the measurement rate rₘ is adaptively adjusted to the temperature measured by the temperature sensor 115. This is illustrated by way of example with reference to FIG. 4:

According to the graph therein, the fill-level measuring device 1 measures the fill level L below a defined limit temperature T_{g} at the temperature sensor 115 of, for example, 100° C. at a constant or undiminished measurement rate rₘ at which it also measures under normal conditions. However, above the limit temperature T_{g}, the fill-level measuring device 1 reduces the measurement rate rₘ linearly as the temperature increases. In contrast to a linear reduction, a stepwise reduction is also conceivable in contrast to the shown illustration. This counteracts primarily the development of heat by the transmission amplifier 113. Thus, with a corresponding reduction in the measurement rate rₘ per ° C., despite a high ambient temperature (for example caused by a cleaning step in the container 2), the temperature in the fill-level measuring device 1 does not exceed a critical maximum temperature Tₘₐₓ of, for example, 150° C. If the temperature sensor 115 nevertheless detects that the critical maximum temperature Tₘₐₓ is being exceeded, the fill-level measuring device 1 can in this case be automatically shut off, for example, given a corresponding design. This ensures, on the one hand, that the fill-level measuring device 1 does not measure any faulty fill-level values L and, on the other hand, does not suffer irreparable damage.

It goes without saying that the control of the measurement rate rₘ according to the invention can also be used for fill-level measuring devices 1 that do not operate according to the pulse time-of-flight or FMCW method. Likewise, the method according to the invention can also be generally used in radar-based distance measurement.

### LIST OF REFERENCE SIGNS

1 Fill-level measuring device

2 Object/filling material

3 Container

4 Higher-level unit

11 Signal-generating unit

12 Antenna arrangement

13 Evaluation unit

111 Ramp-generating unit or pulse generator

112 High-frequency oscillator

113 Amplifier

114 Transmitting/receiving switch

115 Temperature sensor

116 Signal divider

131 Mixer

132 Microcontroller

133 Pulse generator

134 Second high-frequency oscillator

d Distance

E_{HF}, e_{HF} Received radar signal or receive signal

f_{c} Clock rate

f′_{c} Sampling rate

h Installation height or measuring range

IF Evaluation signal

L Fill level

rₘ Measurement rate

S_{HF}, S_{HF} Radar signal or high-frequency signal

S′_{HF} Sampling signal

Φ Relative deviation between the clock rate and the sampling rate

1-8. (canceled)

9. A radar-based fill-level measuring device for measuring a fill level of a filling material located in a container, comprising:
a signal-generating unit designed to generate a high-frequency electrical signal according to an adjustable measurement rate;
an antenna arrangement via which the high-frequency signal can be emitted as a radar signal in a direction of the filling material and can be received as a corresponding receive signal after reflection on a surface of the filling material;
an evaluation unit designed to redetermine the fill level cyclically at least on the basis of the receive signal at the adjustable measurement rate; and
a temperature sensor designed to measure a temperature at the signal-generating unit and/or at the evaluation unit,
wherein the signal-generating unit and the evaluation unit are designed to control the measurement rate as a function of the measured temperature such that, at least above a defined limit temperature, the measurement rate is reduced as the measured temperature increases.

10. The fill-level measuring device according to claim 9, wherein the signal-generating unit and the evaluation unit are designed to control the measurement rate as a function of the measured temperature such that the measurement rate above the limit temperature is reduced linearly or stepwise as the measured temperature increases.

11. The fill-level measuring device according to claim 9, wherein the signal-generating unit and the evaluation unit are designed to stop the fill-level measurement if the measured temperature exceeds a predefined maximum temperature.

12. The fill-level measuring device according to claim 9, wherein at least the signal-generating unit is designed as a monolithic component of an application specific integrated circuit (ASIC).

13. The fill-level measuring device according to claim 12, wherein the signal-generating unit includes a transmission amplifier for amplifying the high-frequency signal, and wherein the temperature sensor is arranged on the transmission amplifier.

14. The fill-level measuring device according to claim 9, wherein the signal-generating unit is designed to generate the high-frequency electrical signal according to a pulse time-of-flight method, and wherein the evaluation unit is designed to determine the fill level according to the pulse time-of-flight method using a sampled receive signal.

15. The fill-level measuring device according to claim 9, wherein the signal-generating unit is designed to generate the high-frequency electrical signal according to a frequency modulated continuous wave (FMCW) method, and wherein the evaluation unit is designed to determine the fill level according to the FMCW method by mixing the high-frequency signal and the receive signal.

16. A method for a radar-based measurement of a fill level of a filling material located in a container, comprising:
providing a radar-based fill-level measuring device, including:
a signal-generating unit designed to generate a high-frequency electrical signal according to an adjustable measurement rate;
an antenna arrangement via which the high-frequency signal can be emitted as a radar signal in a direction of the filling material and can be received as a corresponding receive signal after reflection on a surface of the filling material;
an evaluation unit designed to redetermine the fill level cyclically at least on the basis of the receive signal at the adjustable measurement rate; and
a temperature sensor designed to measure a temperature at the signal-generating unit and/or at the evaluation unit,
wherein the signal-generating unit and the evaluation unit are designed to control the measurement rate as a function of the measured temperature such that, at least above a defined limit temperature, the measurement rate is reduced as the measured temperature increases;
generating the high-frequency electrical signal corresponding to the variable measurement rate;
emitting the high-frequency signal as the radar signal in the direction of the filling material;
receiving the reflected radar signal as the electrical receive signal after reflection on the surface of the filling material;
cyclically redetermining a distance on the basis of at least the receive signal at the adjustable measurement rate;
measuring the temperature at the signal-generating unit and/or at the evaluation unit; and
controlling the measurement rate as a function of the measured temperature such that, at least above a defined limit temperature, the measurement rate is reduced as the temperature increases.
